(19) United States
(12) Patent Application Publication
(10) Pub. No.: US 2004/0045423 A1
(43) Pub. Date: Mar. 11, 2004

(54) Transmission structure of a string saw

(76) Inventor: Chin-Chin Chang, Taichung Hsien (TW)

Correspondence Address: Connolly Bove Lodge & Hutz LLP, P.O. Box 2207, Wilmington, DE, 19899-2207, US

(21) Appl. No.: 10/238,943

(22) Filed: Sep. 10, 2002

(51) Int. Cl. B26D 5/14; B27B 19/04

(52) U.S. Cl. 83/602; 83/697

(57) ABSTRACT

A transmission structure of a string saw includes an upper suspension arm, a lower suspension arm, a drive lever, a first counterweight, a second counterweight. The first counterweight and the second counterweight are arranged on two sides of the bottom of the drive lever in a symmetric manner. Thus, the drive lever, the lower suspension arm, the upper suspension arm, and the saw blade may be moved upward and downward in a rigid and stable manner by balance of the first counterweight and the second counterweight, so that the saw blade at the high speed may be used to saw the workpiece in a rigid and stable manner, without incurring vibration and noise during the sawing process, thereby enhancing the sawing efficiency and quality.

### BACKGROUND OF THE INVENTION

1. Field of the Invention

The present invention relates to a transmission structure of a string saw, and more particularly to a transmission structure of a string saw, wherein the saw blade may be used to saw the workpiece in a rigid and stable manner, without incurring vibration and noise during the sawing process, thereby enhancing the sawing efficiency and quality.

2. Description of the Related Art

A conventional string saw in accordance with the prior art comprises an upper suspension arm, a lower suspension arm, a saw blade, a drive lever, and a motor. In operation, the motor may drive the drive lever to move upward and downward to push the lower suspension arm upward and pull the lower suspension arm downward, so that the saw blade may be used to saw a workpiece placed on the work table of the string saw in a vertical manner. However, the saw blade is operated at a high speed, thereby easily incurring vibration and noise during the sawing process, so that the saw blade cannot saw the workpiece in a rigid and stable manner, thereby reducing the sawing efficiency and quality.

### SUMMARY OF THE INVENTION

The present invention has arisen to mitigate and/or obviate the disadvantage of the conventional string saw.

The primary objective of the present invention is to provide a transmission structure of a string saw, wherein the drive lever, the lower suspension arm, the upper suspension arm, and the saw blade may be moved upward and downward in a rigid and stable manner by balance of the first counterweight and the second counterweight which are arranged in a symmetric manner, so that the saw blade at the high speed may be used to saw the workpiece placed on the work table of the string saw in a rigid and stable manner, without incurring vibration and noise during the sawing process, thereby enhancing the sawing efficiency and quality.

In accordance with the present invention, there is provided a transmission structure of a string saw, comprising an upper suspension arm, a lower suspension arm, a drive lever, a first counterweight, and a second counterweight, wherein:

the drive lever has a top pivotally mounted on the lower suspension arm, so that the lower suspension arm is moved by the drive lever, a bearing is pivotally mounted on a bottom of the drive lever, and has a pivot axle having a first end pivotally mounted on the first counterweight and a second end pivotally mounted on the second counterweight, so that the drive lever, the first counterweight and the second counterweight are moved in concert with each other;

the first counterweight is pivotally mounted on the first end of the pivot axle of the drive lever; and

the second counterweight is pivotally mounted on the second end of the second pivot axle of the second bearing of the drive lever, and is located opposite to the first counterweight, so that the first counterweight and the second counterweight are arranged on two sides of the bottom of the drive lever in a symmetric manner.

Further benefits and advantages of the present invention will become apparent after a careful reading of the detailed description with appropriate reference to the accompanying drawings.

### BRIEF DESCRIPTION OF THE DRAWINGS

FIG. 1 is a side plan cross-sectional view of a transmission structure of a string saw in accordance with a preferred embodiment of the present invention, wherein the drive lever is moved upward to push the lower suspension arm;

FIG. 2 is a cross-sectional view of the transmission structure of a string saw taken along line 2-2 as shown in FIG. 1;

FIG. 3 is a side plan cross-sectional view of the transmission structure of a string saw in accordance with the preferred embodiment of the present invention, wherein the drive lever is moved downward to pull the lower suspension arm;

FIG. 4 is a cross-sectional view of the transmission structure of a string saw taken along line 4-4 as shown in FIG. 3;

FIG. 5 is a top plan view of the lower suspension arm of the transmission structure of a string saw in accordance with the preferred embodiment of the present invention; and

FIG. 6 is a top plan view of the transmission structure of a string saw in accordance with the preferred embodiment of the present invention.

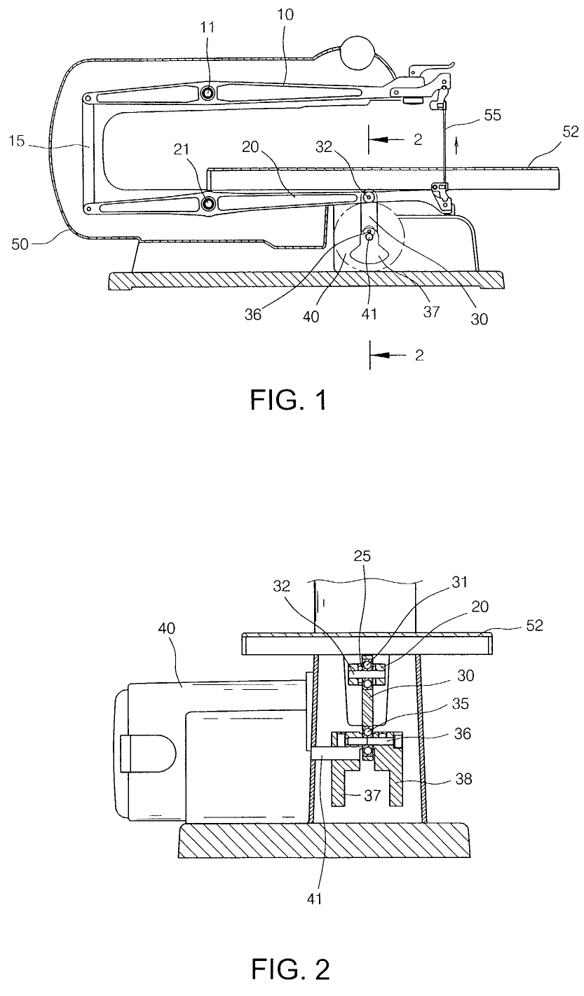

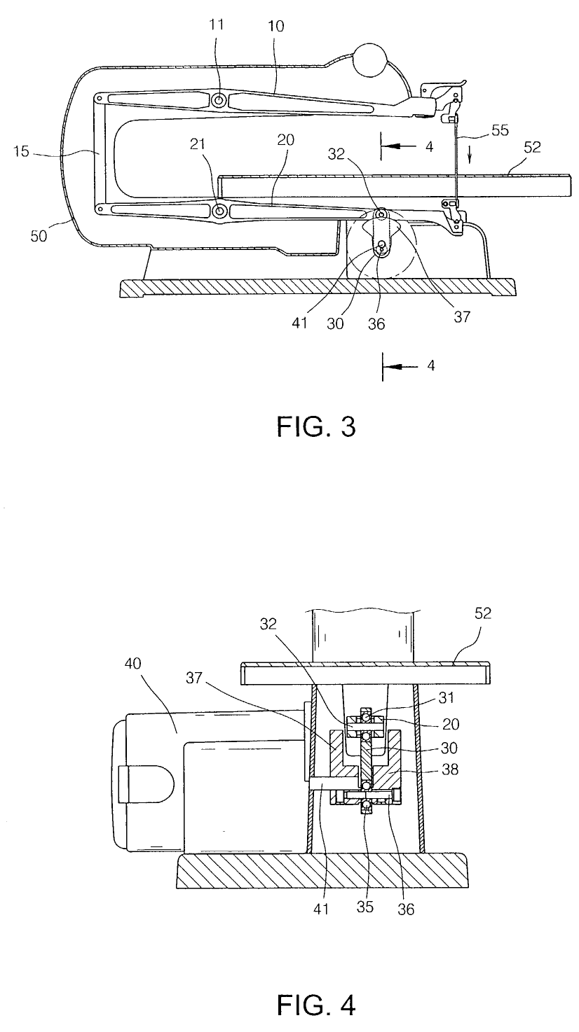

### DETAILED DESCRIPTION OF THE INVENTION

Referring to the drawings, a transmission structure of a string saw in accordance with a preferred embodiment of the present invention comprises an upper suspension arm 10, a lower suspension arm 20, a drive lever 30, a first counterweight 37, a second counterweight 38, and a motor 40.

The upper suspension arm 10 is pivotally mounted on the base frame 50 of the string saw by a pivot shaft 11, so that the upper suspension arm 10 may be pivoted about the pivot shaft 11.

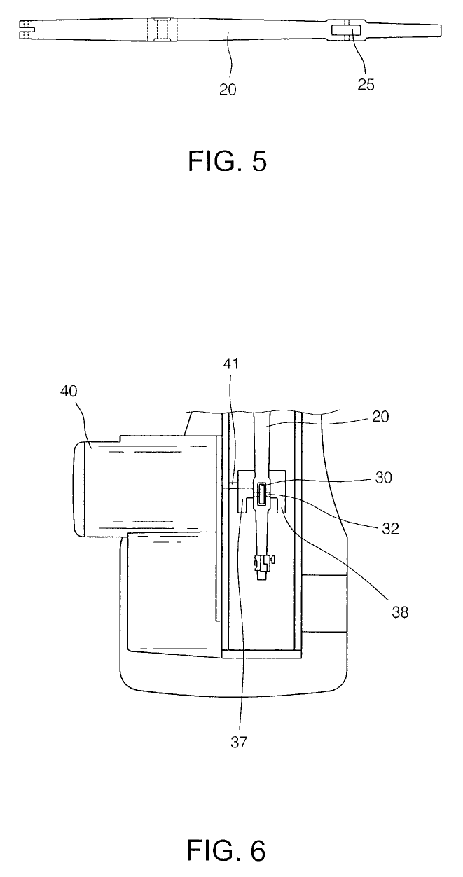

The lower suspension arm 20 is symmetrically located opposite to the upper suspension arm 10, and is pivotally mounted on the base frame 50 of the string saw by a pivot shaft 21, so that the lower suspension arm 20 may be pivoted about the pivot shaft 21. A saw blade 55 is vertically mounted between a front end of the upper suspension arm 10 and a front end of the lower suspension arm 20, and is passed through a work table 52 mounted on the base frame 50 of the string saw, so that the saw blade 55 may be used to saw a workpiece placed on the work table 52 of the string saw in a vertical manner. A link 15 is pivotally mounted between a rear end of the upper suspension arm 10 and a rear end of the lower suspension arm 20, so that the upper suspension arm 10 may be moved in concert with the lower suspension arm 20. The lower suspension arm 20 has a front side formed with an elongated slot 25 (see FIG. 5).

The drive lever 30 has a top pivotally mounted between two side walls of the elongated slot 25 of the lower suspension arm 20. Thus, the drive lever 30 may be moved upward and downward reciprocally to push and pull the lower suspension arm 20 synchronously, so that the saw blade 55 may be moved upward and downward reciprocally to saw the workpiece placed on the work table 52 of the string saw in a vertical manner.

Preferably, a first bearing 31 is pivotally mounted on the top of the drive lever 30, and has a first pivot axle 32 whose two ends are pivotally mounted between the two side walls of the elongated slot 25 of the lower suspension arm 20.

In addition, a second bearing 35 is pivotally mounted on a bottom of the drive lever 30, and has a second pivot axle 36 having a first end pivotally mounted on the first counterweight 37 and a second end pivotally mounted on 11 the second counterweight 38, so that the drive lever 30, the first counterweight 37 and the second counterweight 38 are moved in concert with each other.

The first counterweight 37 has a sector shape, and is pivotally mounted on the first end of the second pivot axle 36 of the second bearing 35 of the drive lever 30. The motor 40 has a drive shaft 41 screwed on the first counterweight 37. Thus, when the drive shaft 41 of the motor 40 is rotated, the first counterweight 37 may be rotated by the drive shaft 41 of the motor 40, so that the second pivot axle 36 of the second bearing 35 of the drive lever 30 may be driven by the first counterweight 37 to rotate about a periphery of the drive shaft 41 of the motor 40, so as to move the drive lever 30 upward and downward in a reciprocal manner.

The second counterweight 38 has a sector shape, and is pivotally mounted on the second end of the second pivot axle 36 of the second bearing 35 of the drive lever 30. The first counterweight 37 and the second counterweight 38 are located at two opposite sides of the bottom of the drive lever 30 symmetrically, so that the drive lever 30 may be moved stably.

In operation, when the drive shaft 41 of the motor 40 is rotated, the first counterweight 37 may be rotated by the drive shaft 41 of the motor 40, so that the second pivot axle 36 of the second bearing 35 of the drive lever 30 may be driven by the first counterweight 37 to rotate about the drive shaft 41 of the motor 40, so as to move the drive lever 30 upward and downward in a reciprocal manner. Thus, the drive lever 30 may be moved upward and downward reciprocally to push and pull the lower suspension arm 20 synchronously, so that the saw blade 55 may be moved upward and downward reciprocally to saw the workpiece placed on the work table 52 of the string saw in a vertical manner. In such a manner, the first counterweight 37 and the second counterweight 38 are located at the two opposite sides of the bottom of the drive lever 30 symmetrically, so that the drive lever 30 may be moved rigidly and stably. Thus, the first counterweight 37 and the second counterweight 38 may provide a balance effect, so that the drive lever 30, the lower suspension arm 20, the upper suspension arm 10, and the saw blade 55 may be moved rigidly and stably.

Accordingly, in the transmission structure of a string saw of the present invention, the drive lever 30, the lower suspension arm 20, the upper suspension arm 10, and the saw blade 55 may be moved upward and downward in a rigid and stable manner by balance of the first counterweight 37 and the second counterweight 38 which are arranged in a symmetric manner, so that the saw blade 55 operated at the high speed may be used to saw the workpiece placed on the work table 52 of the string saw in a rigid and stable manner, without incurring vibration and noise during the sawing process, thereby enhancing the sawing efficiency and quality.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A transmission structure of a string saw, comprising an upper suspension arm, a lower suspension arm, a drive lever, a first counterweight, and a second counterweight, wherein:
the drive lever has a top pivotally mounted on the lower suspension arm, so that the lower suspension arm is moved by the drive lever, a bearing is pivotally mounted on a bottom of the drive lever, and has a pivot axle having a first end pivotally mounted on the first counterweight and a second end pivotally mounted on the second counterweight, so that the drive lever, the first counterweight and the second counterweight are moved in concert with each other;
the first counterweight is pivotally mounted on the first end of the pivot axle of the drive lever; and
the second counterweight is pivotally mounted on the second end of the second pivot axle of the second bearing of the drive lever, and is located opposite to the first counterweight, so that the first counterweight and the second counterweight are arranged on two sides of the bottom of the drive lever in a symmetric manner.

2. The transmission structure of a string saw in accordance with claim 1, wherein the upper suspension arm is pivotally mounted on a base frame of the string saw by a pivot shaft, so that the upper suspension arm may be pivoted about the pivot shaft.

3. The transmission structure of a string saw in accordance with claim 1, wherein the lower suspension arm is symmetrically located opposite to the upper suspension arm, and is pivotally mounted on a base frame of the string saw by a pivot shaft, so that the lower suspension arm may be pivoted about the pivot shaft.

4. The transmission structure of a string saw in accordance with claim 1, further comprising a saw blade vertically mounted between a front end of the upper suspension arm and a front end of the lower suspension arm and passed through a work table mounted on a base frame of the string saw, and a link pivotally mounted between a rear end of the upper suspension arm and a rear end of the lower suspension arm, so that the upper suspension arm may be moved in concert with the lower suspension arm.

5. The transmission structure of a string saw in accordance with claim 1, wherein the lower suspension arm has a front side formed with an elongated slot, and the top of the drive lever is pivotally mounted between two side walls of the elongated slot of the lower suspension arm.

6. The transmission structure of a string saw in accordance with claim 5, further comprising a first bearing pivotally mounted on the top of the drive lever and having a pivot axle whose two ends are pivotally mounted between the two side walls of the elongated slot of the lower suspension arm.

7. The transmission structure of a string saw in accordance with claim 1, further comprising a motor having a drive shaft screwed on the first counterweight, so that the first counterweight may be rotated by the drive shaft of the motor, and the pivot axle of the drive lever may be driven by the first counterweight to rotate about a periphery of the drive shaft of the motor, so as to move the drive lever upward and downward in a reciprocal manner.
